(19) United States
(12) Patent Application Publication
(10) Pub. No.: US 2025/0316023 A1
(43) Pub. Date: Oct. 9, 2025

(54) METHOD AND DEVICE FOR PRODUCING A PLASTIC DESIGN ELEMENT ON AN AUTHENTICATION DATA CARRIER

(71) Applicant: Giesecke+Devrient ePayments GmbH, Munich (DE)

(72) Inventor: Sascha BEHLENDORF, Steinhöring (DE)

(21) Appl. No.: 19/173,005

(22) Filed: Apr. 8, 2025

(30) Foreign Application Priority Data
Apr. 9, 2024 (DE) 102024109774.4

(51) Int. Cl. G06T 17/10; B28B 1/00; G06T 7/13

(52) U.S. Cl. CPC G06T 17/10; B28B 1/001; G06T 7/13

(57) ABSTRACT

A method is proposed for producing a printed pattern containing a plastic design element on an authentication data carrier. For this purpose, individual starting images are provided by users. Printing data, which reproduce the starting image as a planar printed pattern, are generated from the individual starting images by combination with design specifications and boundary conditions. The starting image is applied in a first printing process as a planar printed pattern. Furthermore, an edge detection is carried out on the printing data in order to determine dominating edges in the starting image, which reproduce the contours of the motif contained in the starting image. A 3D printing template is created based on the dominating edges. A three-dimensional printed pattern is applied to the planar printed pattern in accordance with the 3D printing template in a second printing process.

### BACKGROUND

The subject matter of the invention is the printing production of plastic design elements on a planar small-format security element. In particular, the invention is directed to applying a three-dimensional printed pattern on an authentication data carrier. The subject matter of the invention is furthermore a corresponding device for producing a plastic design element on an authentication data carrier.

A method for printing production of raised design elements on a bank card is known from U.S. Pat. No. 9,514,393B2. The design elements are created by repeating a typical 2D printing process multiple times. Different heights are set by controlling the respective number of printing processes carried out and the printing time. 3D printed patterns can be produced in this way. The method is inexpensive but also slow. It requires the accurate calculation of the required printing processes and printing times in a preparation step.

A transaction card is known from WO2017/076489A1, the surface of which is provided with a 3D printed pattern. The printed pattern is applied by means of a printing method for producing three-dimensional objects. Cards having significant 3D effects can be produced. However, the production of corresponding transaction cards requires, in a preparation step, the creation of an individual design containing the raised areas in a machine-readable format. The solution is therefore not commercially suitable for individual designs.

A method for producing a payment card is known from U.S. Pat. No. 10,513,081 B1, on the surface of which contours created by means of 3D printing are formed. The formation of the 3D print takes place in the context of the personalization at a printing station suitable for three-dimensional printing.

A method for producing a three-dimensional motif and information carrier is known from DE 102019203173 A1, according to which digital data of a motif are provided, on the basis of which the surface of a plastically deformable substrate is printed in color. Furthermore, 3D data of the motif are obtained from the digital information, according to which the printed carrier is 3D-embossed using an embossing tool.

A method for creating an edge image from an image template is known from WO2021058097A1, in which a starting image, which is provided in the form of a grayscale image, for example, is converted by means of edge detection into an edge image, which reflects the contours of the motif contained in the starting image in the manner of a painting template. It is the object of the invention to specify an efficient method which permits the formation of effective 3D effects with reasonable preliminary effort.

### SUMMARY

The method according to the invention and likewise the device are distinguished in that they enable a flexible formation of printed patterns having three-dimensional design elements on authentication data carriers. It is possible with reasonable effort to process small to ultrasmall order sizes and obtain good results. The orders can advantageously be executed in a substantially automated manner.

One special advantage of the method according to the invention is the derivation of the 3D printing template from an edge detection in the printing data. The definition of printing thicknesses can thus take place in an automated manner. Moreover, the printing thickness definition can be controlled via many parameters, so that good printing results are achieved.

To carry out the method effectively, the edge detection provided according to the method is preferably only performed in those areas of a printed pattern in which three-dimensional design elements are provided.

The device according to the invention has the advantage that it can be constructed easily with little effort based on components and methods known as such.

Further advantageous refinements and embodiments result from the features of the dependent claims.

### DESCRIPTION OF THE FIGURES

FIG. 1 shows an arrangement for carrying out the method

FIG. 2 shows the steps carried out in the method as a flow chart

FIG. 3 including FIG. 3a and FIG. 3b show an authentication data carrier before and after the application of a printed pattern

### DETAILED DESCRIPTION OF THE INVENTION

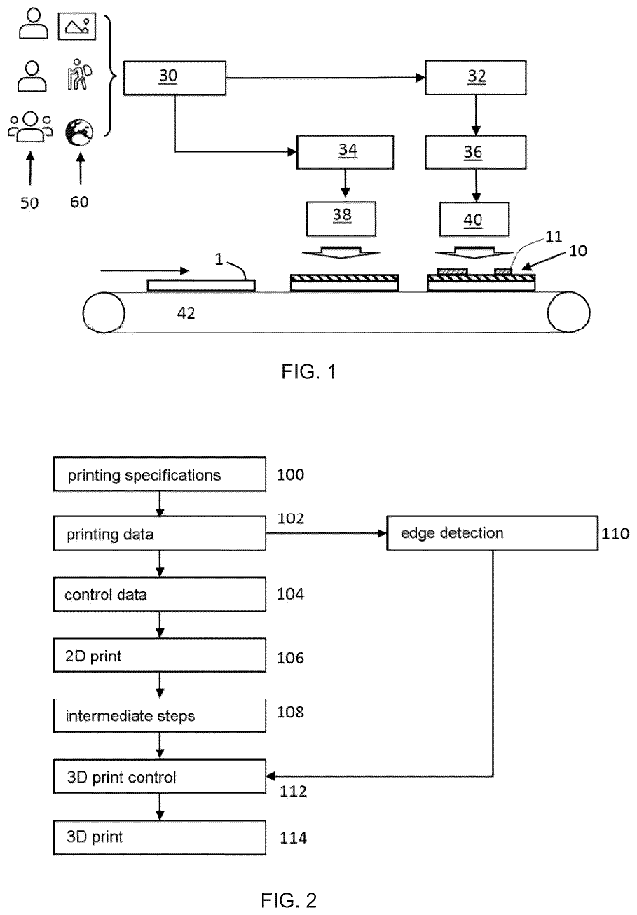

FIG. 1 schematically shows an arrangement for applying a printed pattern 10 to an authentication data carrier 1. The arrangement comprises, not exhaustively, an image preparation unit 30, an edge detection unit 32 connected to the image preparation unit, as well as a first printing control unit 34 and a second printing control unit 36. The first printing control unit 32 is connected to the image preparation unit 30 and the second printing control unit 34 is connected to the edge detection unit 32. Furthermore, the arrangement comprises a first printing unit 38 connected to the first printing control unit 32 for executing 2D printing processes and a second printing unit 40 for executing 3D printing processes, which is connected to the edge detection unit. A transport device 42 for conveying authentication data carriers 1 from the first printing unit 38 to the second printing unit 40 is a further component of the arrangement.

The authentication data carrier 1 has the form of a planar small-format security element. For example, it can be a payment card provided with a chip or an identification card in credit card format. The authentication data carrier 1 can also have the shape of a key ring or a small-format planar object designed in any other way.

The authentication data carrier 1 has at least one surface 2, on which a printed pattern 10 is applied. The printed pattern 10 can comprise graphic, visual, and/or alphanumeric elements. It can be embodied entirely or partially in color or black-and-white. It can cover the entire surface of an authentication data carrier or parts thereof. At least a part of the printed pattern 10 is created based on starting images provided by users 50.

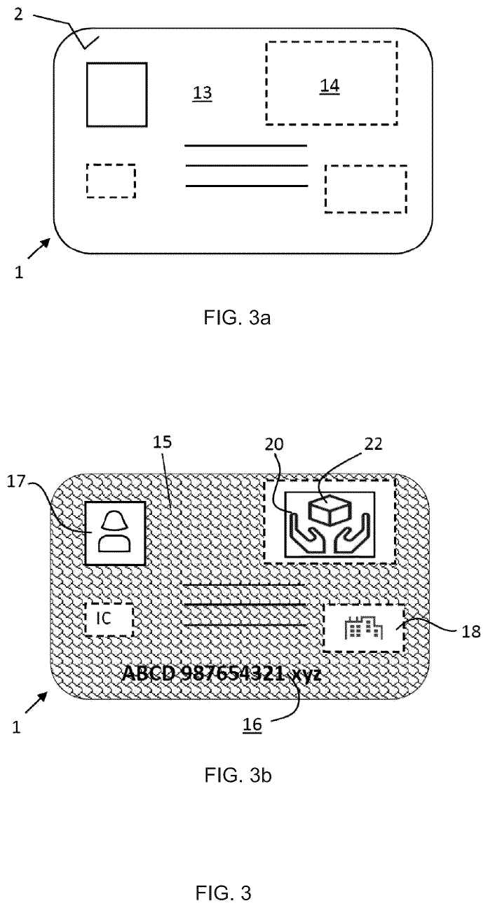

The printed pattern 10 contains at least one plastic design element 11, i.e. an area in which the printed pattern 10 is embodied as a raised print job. The printed pattern 10, as shown in FIG. 3, is expediently divided into first areas 13, in which a typical two-dimensional print is executed, and second areas 14, in which one or more plastic design elements 11 are formed in the form of a raised three-dimensional print job.

As shown in FIG. 3, the printed pattern 1 can consist, for example, of a larger first area 13 and a second area 14 that is smaller in comparison thereto. A graphic base pattern 15 is formed in the first area 13 and alphanumeric information 16, a photo 17, and a graphic element 18 are formed thereon. In the second area 14, a motif 19 in the form of a raised print job is embodied and forms a plastic design element 11. The embodiment of the plastic design element 11 can consist, for example, of the dominating edges 20 of the motif 19 being formed raised.

Printing data are created in the image preparation unit 20. For this purpose, design specifications and boundary conditions specified for a type of authentication data carriers 1 to be processed are combined with individual starting images 60 provided by users 50.

Design specifications can consist, for example, of starting images 60 provided by users 50 only being able to be placed in specific areas of a printed pattern 1 or only in specific areas on an authentication data carrier 1, while a fixed design is specified for the other areas.

Boundary conditions are, for example, the external dimensions of the authentication data carriers 1 to be processed and the specification of areas which cannot or are not permitted to be printed.

The printing data generated by the image processing unit 30 are transferred, on the one hand, to the first printing control unit 34 and, on the other hand, to the edge detection unit 32.

Users 50 can be, for example, individual people who provide starting images 60 having individual desired motifs, or companies which provide starting images 60 having company-specific motifs. The starting images 60 are provided in the form of typical image data sets.

Printing data generated by the image preparation unit 30 can be divided into first area data, which are embodied in the form of a typical two-dimensional print on an authentication data carrier 10, and second area data, in which a three-dimensional print job takes place. The first area data correspond to the first area 13 in the printed pattern, the second area data correspond to the second area 14 in the printed pattern.

The edge detection unit 32 is used to determine possible plastic design elements 11 in the printing data supplied by the image preparation unit 30, which elements are then produced as a three-dimensional print job. The execution of the edge detection can be restricted to the second areas 14. The edge detection takes place by means of a method known as such. The dominating edges 20, which delimit the surface areas 22 contained in the motif defined by the printing data, are determined. The dominating edges 20 reflect the contours of the elements forming the motif 19.

In one embodiment variant, the contours formed by the dominating edges 20 form the plastic design elements 11, which are then produced as a three-dimensional print job. If the areas delimited by the dominating edges 20 are embodied as a flat print, a plastic design element 11 results, the motif 19 of which is contoured by edges 20 embodied as raised. The thickness of the print job is directed, if present, according to specified maximum heights. Maximum heights are usually defined, for example, by credit card organizations and are generally between 0.40 and 0.48 mm.

In another variant, areas 22 enclosed by the dominating edges 20 are then embodied as a three-dimensional print job. It can be provided in this case that both the dominating edges 20 and the contained surface areas 22 are embodied as raised. The contained surface areas 22 and the dominating edges 20 can be embodied in different thicknesses here. The respective thicknesses of the contained surface areas 22 can correspond, for example, to the brightness values for these surface areas 22. For example, surface areas 22 having a brightness lying above a defined limiting value can be embodied having a greater thickness than surface areas 22 having a brightness lying below the limiting value. At the same time, the dominating edges 20 can be embodied in a third thickness. All thicknesses are in turn matched to possibly specified maximum heights. It can also be provided that the thickness with which the contained surface areas 22 are applied depends on further information and/or other information ascertained from the printing data, for example, on the local color or the position within a motif 19 or on the authentication data carrier 1.

The edge detection unit 32 converts the ascertained printing elements into a 3D printing template and transfers it to the second printing control unit 36.

The first printing control unit 34 is used to convert printing data received from the image preparation unit into control data, by means of which the connected first printing unit 38 is caused to apply a typical two-dimensional printed pattern corresponding to the printing data on an authentication data carrier 1.

The second printing control unit 36 is used to convert the 3D printing template received from the edge detection unit 32 into control data, by means of which the connected second printing unit 40 is caused to apply a print job having a thickness defined by the 3D printing template on an authentication data carrier 1. The application of the thickness-increasing print job takes place on the previously created planar printed pattern. The first printing unit 38 is a typical printing unit for applying a planar two-dimensional printed pattern on a flat substrate. The first printing unit can be, for example, a laser printer, an inkjet printer, or a thermal transfer printer.

The second printing unit 40 is a 3D printing machine known per se, for example, a machine of the type UV84, offered by Direct Color Systems (DCS), a digital 3D flatbed printer, etc.

The printing materials used by the two printing units 38, 40 for the print job are matched with one another so that they form a fixed composite. Intermediate steps can be provided for this purpose, in which the created print jobs are subjected to additional material treatments, for example, UV drying for curing a print job or a chemical pretreatment.

The transport device 42 is used to supply authentication data carriers 1 to be processed initially to the first printing unit 38 and then from this to the second printing unit 40, in order to provide them with print jobs in each of the printing units 38, 40. The transport device 42 can be a transport belt, as indicated in FIG. 1. It can also be configured in any other way, however, for example, by means of magazines, which are implemented by robot grippers.

FIG. 2 shows the sequence steps carried out to apply a printed pattern 2 to an authentication data carrier 1 by means of the arrangement shown in FIG. 1.

In a preparatory step 100, printing specifications are provided to the image preparation unit 30. For this purpose, individual starting images 60 are provided by users 50. Furthermore, specified design specifications and boundary conditions are provided for the type of authentication data carriers 1 processed.

In a step 102, the image preparation unit 30 creates printing data from the provided individual starting images 60 and the design specifications and boundary conditions specified for the type of authentication data carriers 1 to be processed. The printing data reproduce the printed pattern 2 and the respective contained individual starting images 60 as a flat printed pattern. The image preparation unit 30 transfers the printing data, on the one hand, to the first printing control unit 34 and, on the other hand, to the edge detection unit 32.

The first printing control unit 34 generates control data for forming a two-dimensional printed pattern, which it forwards to the first printing unit 38, from the received printing data in following step 104.

In accordance with the received control data, the first printing unit 38 applies a planar printed pattern (2D print) onto the supplied authentication data carrier 1 in a first printing process in following step 106.

After completion of the application of the planar printed pattern, the authentication data carrier 1 is conveyed further to the second printing unit 40. Intermediate steps 108 can be provided in this case, for example, a drying process.

During this, the edge detection unit 32 generates a 3D printing template for creating a plastic design element 2 from the printing data received from the image preparation unit 30 in a step 110. The edge detection unit 32 carries out an edge detection by means of a method which is typical as such on the printing data for this purpose, in order to determine the dominating edges 20 in the motifs 19 contained in the printing data, which delimit the motif-forming contained surface areas 22 in relation to one another. The dominating edges 20 reproduce the contours of the elements forming the motif 19. The execution of the edge detection is expediently restricted to the second areas 14. The edge detection unit 32 transfers the ascertained 3D printing template to the second printing control unit 36.

The second printing control unit 36 generates control data for forming a three-dimensional printed pattern, which it forwards to the second printing unit 40, from the received 3D printing template in following step 112.

In accordance with the received control data, the second printing unit 40 applies a raised three-dimensional printed pattern (3D print) over the planar printed pattern applied in the first printing process in a second printing process onto the supplied authentication data carrier 1 in following step 114.

Postprocessing steps—not shown—such as a curing procedure, can follow the application of the three-dimensional printed pattern.

While maintaining the underlying concept of creating a printed pattern having a three-dimensional design element in that initially a planar printed pattern is applied and then a raised printed pattern, which is based on an edge detection carried out on the planar printed pattern, is applied thereon in a separate printing process, the invention permits a series of embodiments which are not specifically implemented. The thicknesses of the dominating edges 20 and contained surface areas 22 can thus be graduated in many steps and the graduation can take place on the basis of further available framework or printing information. The printing processes can take place separately with respect to location and time and further intermediate steps can be provided.

1. A method for producing a plastic design element on an authentication data carrier comprising the following steps:
providing an individual starting image,
generating printing data, which reproduce the starting image as a planar printed pattern,
applying the starting image as a planar printed pattern in a first printing process,
carrying out an edge detection to determine dominating edges in the printing data, which delimit the surface areas contained in the printing data from one another and reproduce the contours of the motif contained in the starting image,
creating a 3D printing template, which is based on the dominating edges found,
applying a three-dimensional printed pattern in accordance with the 3D printing template to the planar printed pattern in a second printing process.

2. The method as claimed in claim 1, wherein, to generate the printing data, the individual starting image provided by the user is combined with design specifications and boundary conditions for the type of authentication data carrier to be processed.

3. The method as claimed in claim 1, wherein the printing data are divided into first area data, which are embodied in the form of a typical two-dimensional print on an authentication data carrier, and second area data, in which a three-dimensional print job takes place.

4. The method as claimed in claim 3, wherein the edge detection is only executed in the second area data.

5. The method as claimed in claim 1, wherein the 3D print is executed using a defined height.

6. The method as claimed in claim 1, wherein the contours formed by dominating edges form plastic design elements, which are produced in the second printing process as a three-dimensional print job.

7. The method as claimed in claim 1, wherein surface areas delimited by the dominating edges are embodied in the second printing process as a three-dimensional print job.

8. The method as claimed in claim 1, wherein the dominating edges are applied with a different thickness than the delimited surface areas.

9. The method as claimed in claim 1, wherein the thickness with which the delimited surface areas are applied depends on further information ascertained from the printing data, in particular the color and/or the position.

10. A device for producing a plastic design element on an authentication data carrier, comprising
an image preparation unit, which is configured to generate printing data from an individual starting image provided by a user, which data reproduce the starting image as a planar printed pattern,
a first printing control unit, which is configured to generate control data for forming a two-dimensional printed pattern from the received printing data,
a first printing unit, which is configured to apply a planar printed pattern to the supplied authentication data carrier in accordance with the control data in a first printing process,
wherein it furthermore comprises:
an edge detection unit, which is configured to carry out an edge detection on the printing data in order to generate a 3D printing template for forming a plastic design element,
a second printing control unit, which is configured to generate a three-dimensional printed pattern from the 3D printing template in the control data, and
a second printing unit, which is configured to apply a three-dimensional printed pattern onto the supplied authentication data carrier onto the planar printed pattern applied in the first printing process in a second printing process.
